(19) United States
(12) Patent Application Publication
(10) Pub. No.: US 2005/0136305 A1
(43) Pub. Date: Jun. 23, 2005

(54) Fuel cell system

(76) Inventors: Gunter Eberspach, Wolfschlugen (DE); Andreas Kaupert, Ulm (DE); Karsten Reiners, Ulm (DE)

Correspondence Address: MCGLEW & TUTTLE, PC, P.O. BOX 9227, SCARBOROUGH STATION, SCARBOROUGH, NY, 10510-9227, US

(21) Appl. No.: 11/007,915

(22) Filed: Dec. 9, 2004

(30) Foreign Application Priority Data
Dec. 22, 2003 (DE) 103 60 458.8

(51) Int. Cl. H01M 8/04

(52) U.S. Cl. 429/26; 429/34

(57) ABSTRACT

A fuel cell system includes a fuel cell (12), a burner (34), which can be operated with fuel or/and fuel cell waste gas as desired. A heat exchanger arrangement (32) is provided to transfer heat generated in the burner (34) to air to be fed into the fuel cell (12) or/and to hydrogen-containing gas to be fed into the fuel cell (12).

### CROSS REFERENCE TO RELATED APPLICATIONS

This application claims the benefit of priority under 35 U.S.C. § 119 of German patent application DE 103 60 458.8 filed Dec. 22, 2003 the entire contents of which are incorporated herein by reference.

### FIELD OF THE INVENTION

The present invention pertains to a fuel cell system.

### BACKGROUND OF THE INVENTION

Fuel cell systems are frequently used in vehicles as so-called auxiliary power sources in order to make it possible to supply users, with electric energy. Such a need is increasingly encountered in vehicles. It is of significance here that such energy uses are frequently to be operated not only when a drive unit designed, e.g., as an internal combustion engine, is also put into operation and thus can also be used to generate electric energy via a generator arrangement. It may be necessary, for example, to activate various systems for preheating a vehicle even before the vehicle is put into use. Besides an auxiliary heater operated with fuel, these systems may also comprise heaters that are to be operated electrically, for example, seat heaters, outside mirror heaters, windshield heaters as well as even delivery means, by which a medium to be heated, for example, the cooling water of a drive unit or the air to be introduced into the interior space of the vehicle, can be delivered through a heat exchanger provided in the area of an auxiliary heater.

There are various requirements in such systems. On the one hand, it shall be ensured during the start phase that the different areas of the system, especially also the fuel cell, will as quickly as possible reach a suitable operating temperature as rapidly as possible. This ensures that the overall system can operate at a high efficiency. On the other hand, the starting materials used to generate energy, i.e., consequently a gaseous medium that is to be introduced into a fuel cell and contains hydrogen, shall be utilized as efficiently as possible in order to increase the efficiency in this respect as well and, of course, to lower the operating costs of the overall system.

### SUMMARY OF THE INVENTION

The object of the present invention is to provide a fuel cell system that can be used in motor vehicles and is able to operate at increased efficiency.

This object is accomplished according to the present invention by a fuel cell system comprising a fuel cell, a burner, which can be operated optionally with fuel and/or fuel cell waste gas, a heat exchanger arrangement for transferring heat generated in the burner to air to be fed into the fuel cell and/or a hydrogen-containing gas to be fed into the fuel cell.

Due to its variability concerning the material to be used for the combustion, the burner provided in the fuel cell system according to the present invention can be activated during different phases of operation in order to make possible in this manner the greatest possible utilization of the energy present in the system or the starting materials being used to generate energy. Thus, by operating the burner with fuel, i.e., for example, with liquid fuel or optionally also with a gaseous fuel, it can be ensured during the start phase, in which, for example, the fuel cell itself cannot yet be used to generate electric energy, that the fuel cell itself will be heated by preheating the air flowing through the fuel cell during this phase and is thus preconditioned to reduce the duration of the start phase. If the fuel cell is put into operation, the fuel cell waste gas leaving the fuel cell, which still contains a considerable percentage of hydrogen not reacted to generate electricity, can be alternatively or additionally introduced into the burner and burned there, e.g., together with the fuel cell waste air which is likewise leaving the fuel cell and was also preheated. The heat thus generated can in turn be transferred to the air to be introduced into the fuel cell and optionally also to the hydrogen-containing gaseous medium to be introduced into the fuel cell in order to make it possible to obtain an improved operating characteristic of the fuel cell itself. Furthermore, it is, of course, possible to utilize the heat generated in the burner during the combustion, which is not transferred to the media to be introduced into the fuel cell, in another heat exchanger arrangement to heat, for example, the air to be introduced into the interior space of a vehicle or even to heat the cooling medium present in the cooling circulation of an internal combustion engine in order to also make it possible in this manner to achieve preconditioning in the area of the internal combustion engine.

Provisions may be made in the system according to the present invention for the burner to comprise a combustion chamber with a feed line for fuel, a feed line for fuel cell waste gas and a feed line for combustion air. It is, furthermore, advantageous, in this case for the feed of fuel and the feed of fuel cell waste gas to take place via a common feed line, which feeds the fuel and the fuel cell waste gas, respectively, in the bottom area in the direction of the combustion chamber.

To keep the design of the system according to the present invention as simple as possible, it is proposed, furthermore, that the feed of fuel and the feed of fuel cell waste gas take place via a common feed line, which feeds the fuel and the fuel cell waste gas, respectively, in the bottom area in the direction of the combustion chamber. To separate the paths of introduction of the fuel, it may be advantageous, especially if a liquid medium, i.e., for example, fossil fuel, such as gasoline or diesel or biodiesel is used, to feed fuel and fuel cell waste gas via separate feed lines, which feed the fuel and the fuel cell waste gas, respectively, in the bottom area in the direction of the combustion chamber.

Very good mixing of the combustion air to be introduced into the combustion chamber with the fuel or fuel cell waste gas, which is likewise to be introduced into the combustion chamber or is already present there, can be achieved by feeding fuel and fuel cell waste gas via separate feed lines, which feed the fuel and the fuel cell waste gas, respectively, in the bottom area in the direction of the combustion chamber. The efficiency of the combustion can be further improved by optimized mixing by providing a premixing chamber, in which at least part of the fuel cell waste gas and at least part of the combustion air are mixed before being fed into the combustion chamber.

To bring especially liquid fuel to a state in which it forms an ignitable and combustible mixture, it is proposed that a porous evaporator medium, preferably one with a heating means, be provided at least in the bottom area of the combustion chamber, via which evaporator medium at least the fuel is fed into the combustion chamber.

It is proposed in an alternative embodiment that the burner have an atomizer arrangement with a feed line for liquid fuel, a feed line for combustion air, which is also used to atomize the fuel, and a feed line for fuel cell waste gas.

Provisions may be made in this connection for the atomizer arrangement to have an outer swirl flow space and an inner swirl flow space to generate an outer swirl flow and an inner swirl flow leading to an atomization lip and for the feed line for fuel cell waste gas to comprise a feed line through which the fuel cell waste gas is introduced into the area of the inner swirl flow and/or the outer swirl flow.

Provisions may, furthermore, be made in an embodiment that has a simple design and yet ensures efficient mixing for the feed line to pass through a flow guide element, which defines the inner swirl space.

The present invention will be described in detail below on the basis of the attached drawings based on preferred embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a block diagram of a fuel cell system according to the present invention;

FIG. 2 is a partial sectional view of a burner that can be used in the system according to FIG. 1;

FIG. 3 is a view corresponding to FIG. 2 of an alternative embodiment of the burner;

FIG. 4 is another view corresponding to FIG. 2 of an alternative embodiment of a burner;

FIG. 5 is another view corresponding to FIG. 2 of an alternative embodiment of a burner;

FIG. 6 is another view corresponding to FIG. 2 of an alternative embodiment of a burner;

FIG. 7 is another view corresponding to FIG. 2 of an alternative embodiment of a burner;

FIG. 8 is a simplified axial sectional view of the burner shown in FIG. 7; and

FIG. 9 is a partial sectional view of an atomizer arrangement for a burner that can be used in the system according to FIG. 1.

### DESCRIPTION OF THE PREFERRED EMBODIMENTS

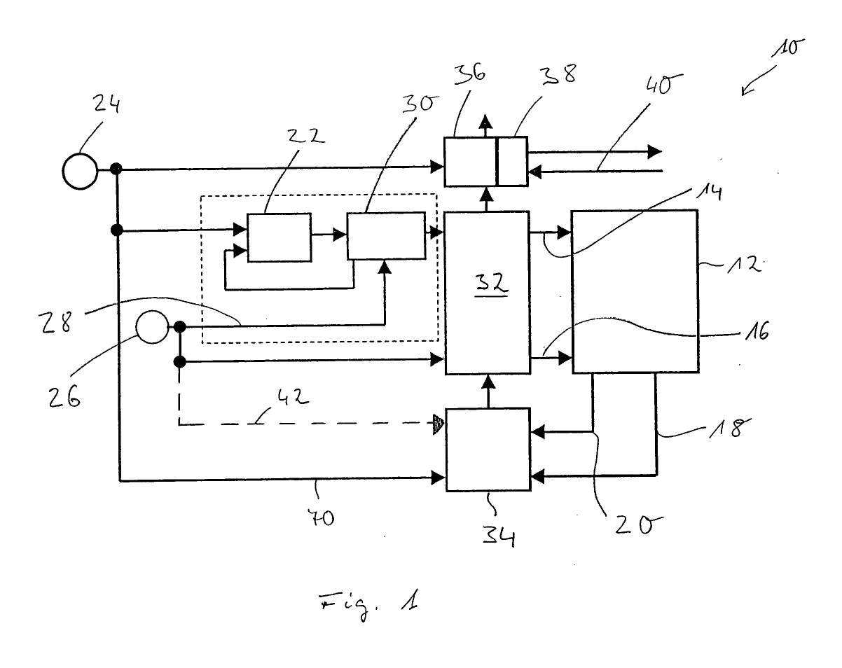

A fuel cell system according to the present invention is generally designated by 10 in FIG. 1. This fuel cell system 10 has as its essential component a fuel cell 12, into which a hydrogen-containing gas is introduced, as is indicated by an arrow 14, and, as is indicated by arrow 16, air, i.e., oxygen, is introduced. The hydrogen contained in the hydrogen-containing gas is reacted in the fuel cell 12 with the oxygen contained in the air to generate electric energy. As is indicated by an arrow 18, a hydrogen-depleted fuel cell waste gas and, as is indicated by an arrow 20, an oxygen-depleted fuel cell waste air will then leave the fuel cell 12.

The hydrogen-containing gas to be fed into the fuel cell 12 is prepared in a reformer 22 in the fuel cell system being shown. This reformer 22 is fed by a fuel supply means 24 with fuel, generally liquid fuel, e.g., gasoline, diesel fuel or another hydrocarbon. Furthermore, air is fed into the reformer 22 by an air supply means 26, and, as is indicated by an arrow 28, this air flows through a heat exchanger 30 before being fed into the reformer 22 and can take up heat in the process during the reforming operation from the hydrogen-containing gas leaving the reformer 22, which is generally also called reformate. The air thus enters the reformer 22 in an already preheated state.

It shall be pointed out here that the fuel supply means 24 and the air supply means 26 may have suitable delivery members, e.g., pumps or blowers in order to obtain the desired fuel and air flows.

The hydrogen-containing gas leaving the reformer 22 via the heat exchanger 30, i.e., reformate, will then flow in the direction of the fuel cell 12 and can be sent through an additional heat exchanger 32 before being fed into the fuel cell. The air to be delivered in the direction of the fuel cell 12 by the air supply means 26, which supplies not only the reformer 22 but also the fuel cell 12 with the air necessary for carrying out the desired reaction, also flows through this heat exchanger 32 and can take up heat therein. The air to be introduced into the fuel cell 12 thus enters the fuel cell 12 already in a state in which the air has a temperature that is suitable for permitting the desired reaction to take place. Furthermore, by heating this air in a phase in which the fuel cell 12 is not yet being operated to produce electric energy, this air can be used to precondition, i.e., preheat the fuel cell 12.

To make it possible to make available the heat to be transferred in the heat exchanger 32 to the air and optionally to the hydrogen-containing gas, a burner 34 is arranged upstream of the heat exchanger 32. This burner 34 is designed to burn various combustible media with oxygen in order to then send the hot combustion waste gases in the direction of the heat exchanger 32 and to preheat the gaseous media mentioned, namely, air and reformate, in the process. It can be recognized from FIG. 1 that a combustible medium can be fed to the burner 34 by both the fuel supply means 24 in the form of the fuel being delivered by same and to the fuel cell 12 in the form of the fuel cell waste gas. Furthermore, the fuel cell waste air 20, which still contains oxygen, is fed to the burner 34, so that not only a combustible medium, but also the oxygen necessary for the oxidation is made available for the combustion in the burner 34.

The heat exchanger 32 is followed by another burner 36 with a heat exchanger 38 associated therewith. Fuel can be fed into the burner 36 by the fuel supply means 24. Furthermore, the waste gas or gaseous medium leaving the burner 34, which still contains at least a percentage of oxygen that can be utilized for combustion in the burner 36, can be fed to the burner 36 via the burner 34 and the heat exchanger 32. A medium, which is to be heated, can be fed to the heat exchanger 38, as is indicated by an arrow 40, to take up heat. This medium, which is to be heated, may be, for example, the air, which is to be introduced into the interior space of a vehicle and is to be heated in advance, or, as an alternative or in addition, it may, of course, also be the cooling medium, which may circulate in a cooling circuit of a drive unit.

Before explaining various embodiments of the burner 34 in detail below, the operation of the fuel cell system 10 according to the present invention will be described with reference to FIG. 1.

It shall first be assumed that a vehicle equipped with such a system 10 is not yet put into operation, but that, for example, the vehicle is nevertheless to be preheated or preconditioned. The various areas of the system are still cold during this phase. The burner 34 is therefore activated at first, doing so by feeding fuel from the fuel supply means 24 and by feeding combustion air from the air supply means 26. This combustion air will then flow over the heat exchanger 32, through the fuel cell 12 and as a “fuel cell waste air” into the burner 34. The hot combustion waste gases produced in the burner 34 are sent in the direction of the heat exchanger 32. They heat the air being delivered by the air supply means 26 in the direction of the fuel cell 12 and the burner 34 in the process. This heated air will in turn heat the fuel cell 12 from the inside and thus prepare same already for the operation to generate electric energy. After flowing through the heat exchanger 32, the combustion waste gases of the burner 34, which have already cooled somewhat, flow in the direction of the burner 36. If the interior space of the vehicle is also to be preheated or a drive unit is optionally to be preheated during this phase, fuel may additionally also be fed to the burner 36 from the fuel supply means 24 in order to burn the oxygen still contained in the combustion waste gases of the burner 34 with this fuel and to subsequently transfer the heat formed in the process to the medium to be heated in the heat exchanger 38. The air supply means 26 delivers so much oxygen in the direction of the burner 34 for this purpose that the waste gases leaving this burner 34 will still transport a sufficient amount of oxygen. It is consequently unnecessary to provide an additional air supply line for the burner 36. If the temperature of the waste gases leaving the heat exchanger 32 is still high enough to bring the medium to be heated in the heat exchanger 38 to the desired temperature, it would not be necessary during this phase of the operation to additionally activate the burner 36. It would also be possible in this case, in principle, if the burner 34 or the heat exchanger 38 is dimensioned correspondingly, to omit the burner 36 altogether and to use the heat, which is also to be transported in the combustion waste gases 34 to the heat exchanger 32, to bring the medium to be heated to the desired temperature.

Since the on-board electrical system is under a very high load during this phase of operation, especially at comparatively low outside temperatures, and the on-board electrical system is represented, in general, by a battery during this phase, it is advantageous to also operate or put into operation the fuel cell 12 to generate electric energy. Therefore, the reformer 22 is also activated, doing so by supplying hydrocarbon and air that is necessary for the reforming. The reformer 22 may now also be preheated in order to bring it to the desired operating temperature very rapidly. This preheating could optionally or alternatively also be carried out by means of a separate heating means, for example, a heating means that can be operated electrically.

A gas containing hydrogen is produced during the reforming operation that is now taking place in the reformer 22, and this gas will flow at a very high temperature in the direction of the heat exchanger 30 and, as was mentioned already, preheat the air to be fed into the reformer. The reformate that will now leave the heat exchanger 30 can be sent either directly in the direction of the fuel cell 12 or, as is indicated in FIG. 1, it will flow through the heat exchanger 32 and take up some more heat in the process. If preheated air is now introduced into the fuel cell 12 together with the likewise very hot reformate, the reaction of hydrogen being transported in the hydrogen-containing gas with the oxygen contained in the air to yield water can take place in the fuel cell 12 while electric energy is generated. This electric energy can in turn be used, for example, to operate heating means optionally present in the different burners 34, 36 and also in the reformer 22 and optionally also other users of electric energy that are to be operated in a vehicle during this phase of operation. Thus, the entire system will not load the on-board electrical system or the battery present therein any longer.

Once the fuel cell 12 is put into operation or a reformate containing hydrogen is fed by the reformer 22 in the direction of the fuel cell 12, a fuel cell waste gas, which still contains hydrogen, will leave the fuel cell 12 even if it has been put into operation. Since this hydrogen can be burned together with the oxygen still contained in the fuel cell waste air in the burner 34, it is no longer necessary during this phase to supply the burner 34 with fuel from the fuel supply means 24.

The heat balance is affected in the system described above and shown in FIG. 1 essentially by the amount of air delivered by the air supply means 26 in the direction of the fuel cell 12. The larger the amount of air, the more oxygen is also available in the burner 34 when the fuel cell 12 is in operation, and more oxygen is consequently also available in the burner 36. Furthermore, the consequence of the supply of a larger amount of air is that when the fuel cell 12 has been put into operation, a sufficient amount of heat can be removed from the fuel cell 12, and it is also ensured at the same time by preheating the air to be introduced into the fuel cell 12 that a load on the fuel cell 12, which occurs due to excessive differences in temperature, can be avoided. To further affect the heat behavior especially of the fuel cell, it may be necessary, as is also indicated by a line connection 42 drawn in broken line, to feed air into the burner 34 directly from the air supply means 26. This air or the oxygen contained therein will not be necessary to allow the combustion to take place in the burner 34. The oxygen still contained in the fuel cell waste air is sufficient for this. The consequence of this supply of additional air is rather that the very hot waste gases of the burner 34 will be cooled somewhat, so that the air, which is to be fed into the fuel cell 12 and which flows for this purpose beforehand through the heat exchanger 32, can enter the fuel cell 12 at a suitable temperature.

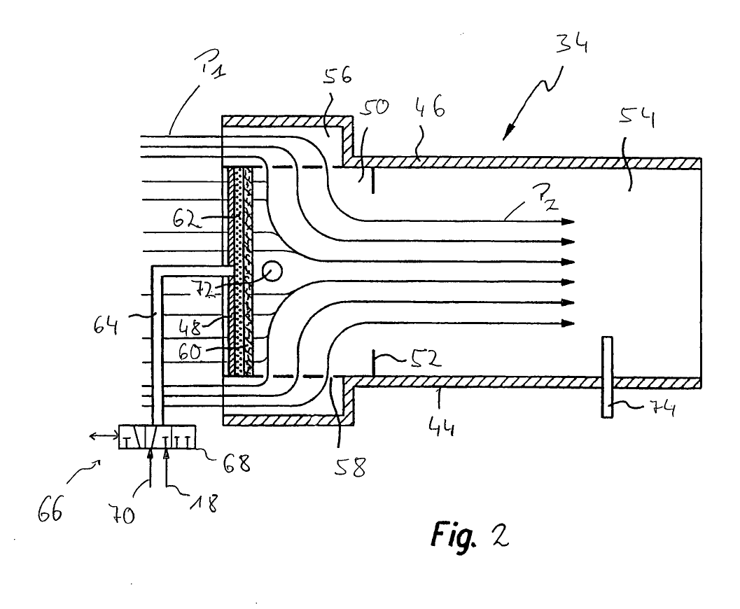

Various embodiments of the burner 34 and of the system components of this burner 34 will be described in detail below. The burner 34 shown in FIG. 2 comprises a burner housing, generally designated by 44, with a circumferential wall area 46 and a bottom wall area 48. The circumferential wall area 46 and the bottom wall area 48 define a combustion chamber 50, which is open via a flame baffle or a flame retention baffle 52 to a volume area 54 leading in the direction of the heat exchanger 32. In its section near the bottom wall area 48, the circumferential wall area 46 is surrounded by an annular space 56. This annular space 5 is in connection with the combustion chamber 50 via a plurality of openings 58. As is indicated by arrows P₁, combustion air can thus flow into the combustion chamber 50 radially from the outside. The bottom wall area 48 may also have a plurality of such openings, which are not shown in FIG. 2 and through which at least a portion of the combustion air can enter the combustion chamber 50. As was already described above with reference to FIG. 1, this combustion air is fed essentially in the form of the fuel cell waste air (arrow 20 in FIG. 1) in the direction of burner 34.

The combustion chamber 50 is defined in the direction of the bottom wall area 48 by a porous evaporator medium 60, which covers the bottom wall area 48 essentially completely. This porous evaporator medium 60 may be a braiding, a knitted fabric, a foam ceramic or another material provided with fine pores, in which liquid fuel can be distributed by capillary action. A heating means 62, which can be operated electrically, may be positioned between the porous evaporator medium 60 and the bottom wall area 48 in order to heat the porous evaporator medium 60 and to support the evaporation of the fuel being distributed therein in the direction of the combustion chamber 50.

A feed line 64 opens into the bottom wall area 48 or the combustion chamber 50 in a central area. Both the fuel, which is being fed by the fuel supply means 24 and is generally liquid, and the fuel cell waste gas, i.e., a gas still containing hydrogen, can be fed in via this feed line 64 in this embodiment. A valve arrangement 66, which is shown only schematically, is provided to make it possible here to choose between the different fuels. This valve arrangement comprises a valve slide 68, which connects either the line 18 coming from the fuel cell 12 with the feed line 64 or the line 70 coming from the fuel supply means 24 with the feed line 64, or does not connect any of these lines 18, 70 with the feed line 64, depending on the positioning in one of the three possible switching positions. If the line 70 is connected with the feed line 64, liquid fuel is consequently introduced into the porous evaporator medium 60. This fuel is distributed by capillary action over the entire porous evaporator medium and will also evaporate on the side of the porous evaporator medium facing the combustion chamber 50 in the direction of the combustion chamber 50 because of the heating action of the heating means 62. An ignitable and combustible mixture is generated now with the air, which is likewise introduced into the combustion chamber 50, i.e., the fuel cell waste air, which contains more or less oxygen depending on the operating state of the fuel cell 12. An igniting member 72, for example, a glow type igniting pin, is arranged at a closely spaced location above the porous evaporator medium 60 to start this combustion. Once the ignition has taken place, the hot combustion waste gases flow in the direction of the heat exchanger 32, as is indicated by the arrows P₂, and will also flow past, e.g., a temperature sensor 74, which can thus determine, by sensing the temperature of the gases leaving the combustion chamber 50, whether ignition has already taken place or not.

If hydrogen-containing gas is available for the combustion via the line 18, the valve is reversed and the line 18 is now connected with the feed line 64. The hydrogen-containing gas will then flow through this feed line 64 and the bottom wall area 48 and enter the combustion chamber 50 in the local area, in which the feed line 64 is open toward the porous evaporator medium 60, it will be mixed there with the air available for the combustion and likewise produce an ignitable and combustible mixture.

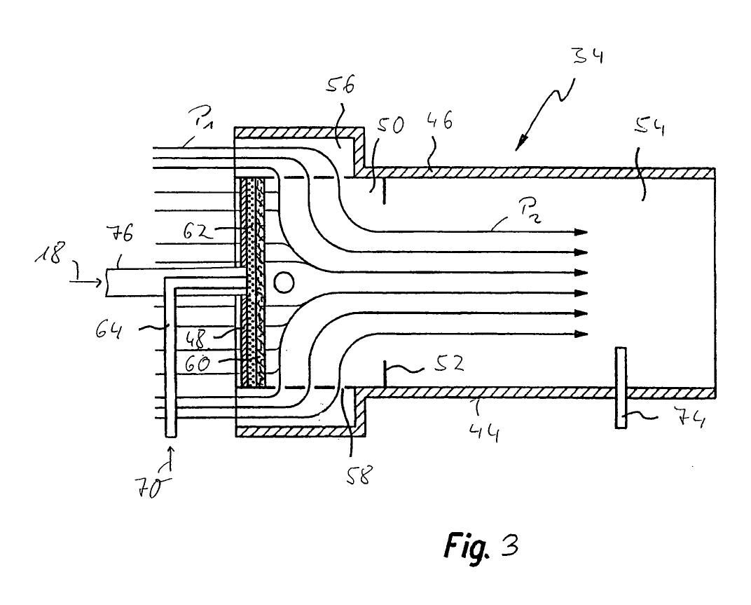

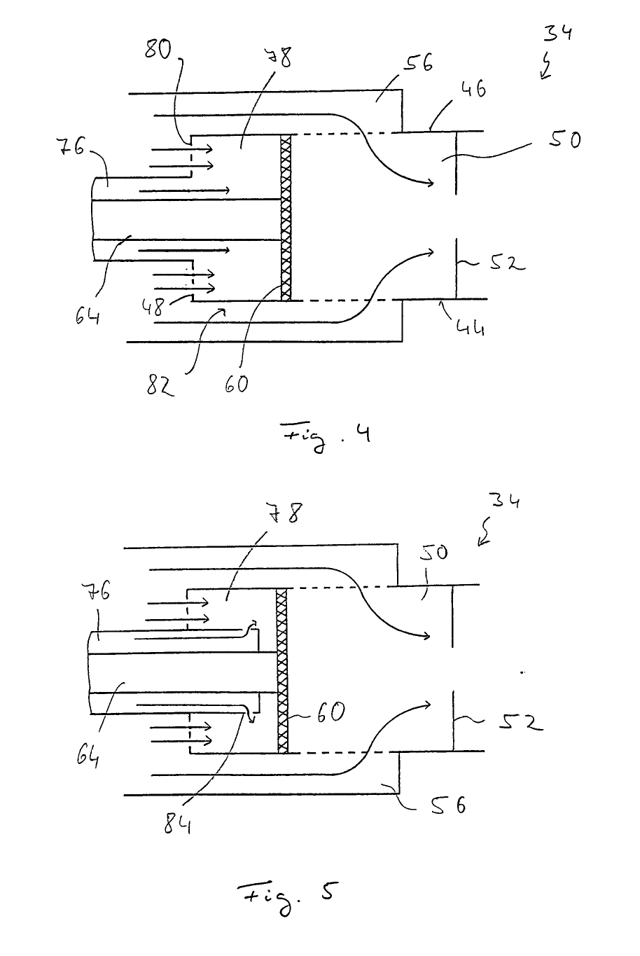

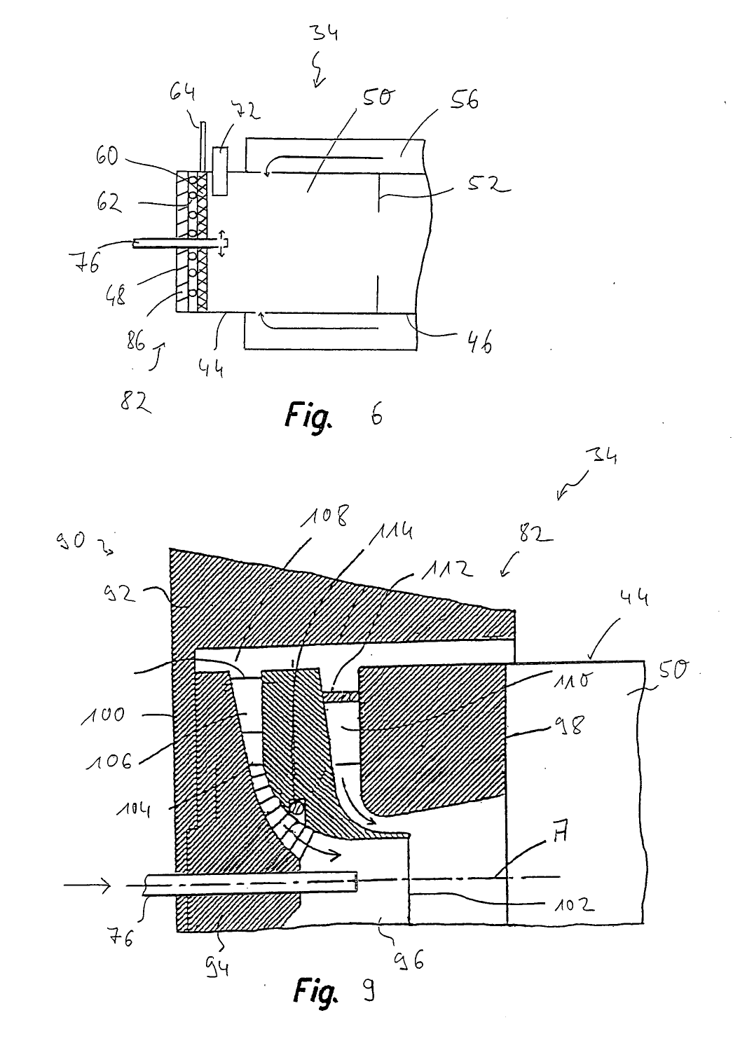

A variant of such a burner is shown in FIG. 3. It can be recognized here that while the design is basically the same, there is a difference only in the area of the feed of the different media used for the combustion. Furthermore, the feed line 64 is present, via which liquid fuel is now introduced into the porous evaporator medium 60, which is fed, for example, from the line 70. Furthermore, a feed line 76 is provided, which surrounds the feed line 64 at least in the end section that is close to the bottom area 48 and is now in connection with the line 18 and can supply the hydrogen-containing gas in the direction of the combustion chamber 50. Consequently, since separate feed lines 64 and 76 are available here for the fuel, on the one hand, and the fuel cell waste gas, on the other hand, a valve mechanism 66, as is shown in FIG. 2, can be omitted, in principle. Furthermore, it is possible in this variant, by providing a separate feed line for the fuel cell waste gas, to feed this fuel cell waste gas into the combustion chamber 50 in an optimized manner, i.e., without being dependent on the site of the fuel feed via the feed line 64. Thus, the coaxial feed shown in FIG. 3 is not absolutely necessary. The fuel cell waste gas can rather be fed in, distributed over the bottom wall area 48, via a plurality of introduction points in the direction of the combustion chamber 50. Improved mixing of the fuel cell waste gas with the fuel cell waste air or the combustion air can thus be achieved.

An embodiment, in which such mixing can be further improved, is shown in FIG. 4. It is recognized here that an intermediate space, which provides a premixing chamber 78, is formed between the bottom wall area 48 and the porous evaporator medium 60. At least part of the air used for the combustion, i.e., the fuel cell waste air, enters this premixing chamber 78 through openings 80 provided in the bottom wall area 48. Furthermore, the feed line 76 is open toward this premixing chamber 78 in the area in which it is connected to the housing 44. The fuel cell waste gas thus mixes with the fuel cell waste air before being fed into the combustion chamber 50 via the porous evaporator medium 60. Since no liquid fuel is fed into the porous evaporator medium 60 via the feed line 64 during the phase during which the fuel cell waste gas is used for the combustion, the pores of this evaporator medium are also not blocked by liquid, so that the mixture produced in the premixing chamber 78 in a bottom area of the combustion chamber 50 or the housing 44, which area is generally designated by 82, can enter the combustion chamber 50 without greater resistance and can burn there. The porous evaporator medium 60 also forms a flame retention baffle in this exemplary embodiment or in this phase of the operation, which ensures that no combustion will take place in the premixing chamber 78 itself.

A variant of this embodiment is shown in FIG. 5. It can be recognized here that the feed line 76 extends into the area of the premixing chamber 78 and has a plurality of radially outwardly leading openings 84 there. This can also contribute to improved mixing of the fuel cell waste gas with the fuel cell waste air.

It shall be pointed out that a heating means, e.g., one in the form of a heating coil, may, of course, be associated with the porous evaporator medium 60 in the embodiment variants according to FIGS. 4 and 5 as well, in order to improve the evaporation of the liquid fuel in the direction of the combustion chamber 50 when such a liquid fuel is fed in via the feed line 64.

Another embodiment of such a burner is shown in FIG. 6.

The housing 44 with the circumferential wall area 46 and the bottom wall area 48 can be recognized here as well. Adjoining this bottom wall area 48 and in the bottom area 82, an insulating material layer 86 is provided, which is then followed by the heating means 62 as well as the porous evaporator medium 60. The feed line 76 for the fuel cell waste gas extends in the central area of this bottom area 82. This feed line 76 extends through the bottom wall area 48 and also the porous evaporator medium 60 and is then open toward the combustion chamber 50 via one opening or a plurality of openings. The fuel is fed here via the feed line 64 led in radially. The advantage of this embodiment is that the fuel cell waste gas can be fed regardless of whether liquid fuel is still present in the porous evaporator medium and whether such fuel consequently covers the pores of the evaporator medium. This also guarantees easier introduction of the fuel cell waste gas in the bottom area 82 and consequently improved mixing with the combustion air or fuel cell waste air, which is to be introduced again radially from the outside, but optionally also through openings in the bottom wall area 48.

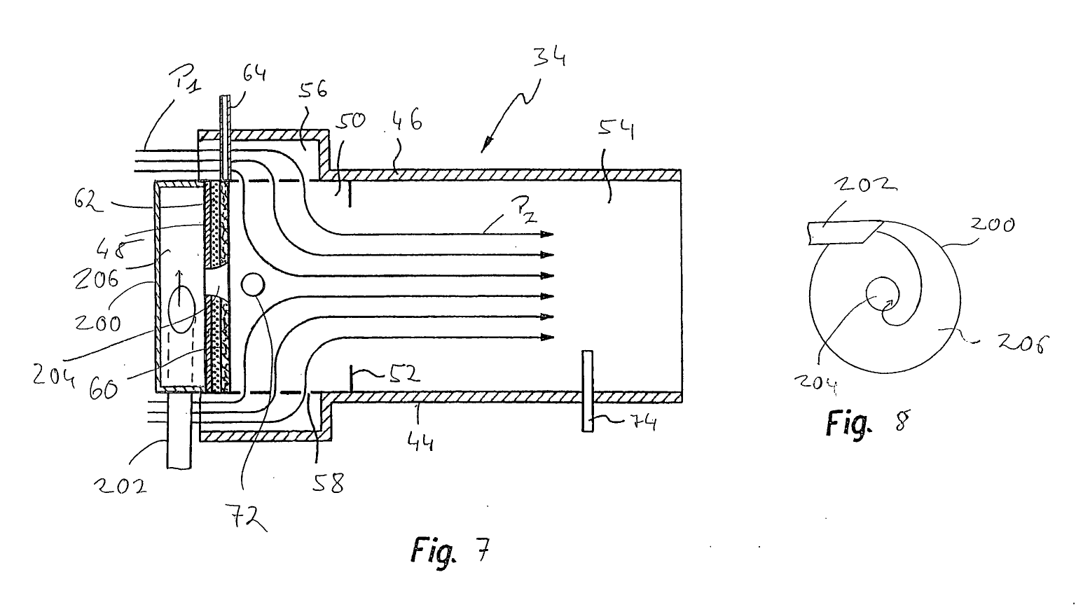

Another alternative embodiment is shown in FIGS. 7 and 8. It can be recognized that the design corresponds basically to the burner shown in FIG. 2. However, the feed line 64 now opens into the porous evaporator medium 60 radially from the outside and supplies fuel to the evaporator medium radially from the outside. Since, as is illustrated in FIG. 7, the fuel is fed in radially from the outside and preferably from the top, it can be distributed very uniformly in the porous evaporator medium, utilizing the force of gravity, which forces it to move downward.

The bottom wall area 48 is covered by a housing 200 on its side facing away from the combustion chamber 50. As is illustrated in FIG. 8, a gas feed line 202 opens essentially tangentially into this housing 200. This gas feed line 202 may be in connection, directly or optionally via a valve arrangement, with the line 18 recognizable in FIG. 1, via which the anode waste gas, i.e., a gas still containing residual hydrogen, can be fed. Openings providing a nozzle-like passage opening 204 each are provided in a central area in the bottom wall area 48, the heating means 62 and the porous evaporator medium 60 each. This nozzle-like passage opening 204 has a cross section expanding in the direction of the combustion chamber and forms a swirl nozzle for the gas flowing tangentially into the housing 200 from the line 202. As is indicated in FIG. 8, a swirl-like turbulence of the gas introduced into the combustion chamber 50 is generated during this flow of the gas leaving the fuel cell via the line 18 via a swirl chamber 206 formed in the housing 200 and the nozzle-like opening 204, as a result of which extraordinarily good mixing, e.g., with the combustion air being introduced radially from the outside, is brought about. To prevent backflash of the flame from the combustion chamber 50, a flame barrier, for example, one in the form of a grid or another structure provided with openings, may be provided in the area of the passage opening 204 and even in the area in which the line 202 opens intro the chamber 206.

Valve devices may be associated separately with the feed line 64 as well as the gas line 202 in order to make it possible to close and open these lines as desired and thus to introduce the fuel cell waste gas or the fuel into the combustion chamber 50 as desired.

An alternative embodiment of a burner 34 to be used in the system according to FIG. 1 is shown in FIG. 9. While the burners described above with reference to FIGS. 2 through 8 operate according to the principle of an evaporator burner in case of use of a liquid fuel, i.e., the mixture of fuel and combustion air is provided by evaporating the fuel, a so-called atomizer arrangement 90 is provided in the burner 34 being shown in FIG. 9. An initially liquid fuel is atomized by this atomization device 90 into very fine fuel particles and fed together with the combustion air into the combustion chamber 50 provided in the housing 44. This atomizer arrangement 90 also forms essentially the bottom area 82 of the combustion chamber 50 or of the housing 44.

It can be recognized from FIG. 9 that this atomizer arrangement 90 comprises a nozzle body which is generally designated by 92 and has an essentially pot-shaped design. Three insert parts 94, 96, 98 are inserted into this nozzle body 92 in an axially staggered manner, axial being related to a longitudinal axis of the burner 34. The insert part 94 is arranged here seated on a bottom 100 of the nozzle body 92 and has a shape that tapers concavely in the direction of the axis A and is preferably rotationally symmetrical with this axis A.

The second insert part 96 is arranged at a spaced location from the first insert part 94 and has an approximately cylindrical section terminating in an atomizer lip 102 in its radially inner area. An inner swirl flow space 104, in which a plurality of flow deflecting elements 106 ensure that the combustion air, introduced from a radially outer, annular space 108, i.e., again the fuel cell waste air here, will also receive a circumferential flow component during the flow radially from the outside to radially to the inside and is thus sent in the direction of the atomizer lip 102 in the form of a flow provided with a swirl around the axis A, is formed between the first insert part 94 and the second insert part 96.

The third insert element 98 is arranged axially after the second insert part 96 and at a spaced location from same. An intermediate space, which defines an outer swirl flow space 110, is also provided between these two insert parts 96, 98. A plurality of flow deflecting elements 112 are provided here as well. These ensure that the air arriving radially from the outside will likewise contain a circumferential component, so that a flow provided with a swirl will also flow from the outside in the direction of the atomizer lip 102.

A groove-like hollow 114 is provided in the second insert part 96 on its side defining the inner swirl flow space 104. The liquid fuel to be atomized is introduced into this hollow and distributed in the circumferential direction by a fuel distributing element indicated only schematically. Thus, this fuel reaches the surface area of the second insert part 96 that is swept by the inner swirl flow and is transported in the direction of the atomizer lip 102 under the delivery action of the inner swirl flow. If the fuel, which is initially still liquid and forms a thin coating film on the second insert part 96, then reaches the atomizer lip 102, it is disintegrated into very fine particles by the two swirl flows converging there, and these particles can then be burned in the combustion chamber 50 with the combustion air.

It shall be pointed out that the design of such an atomizer arrangement 90 is basically known from DE 102 05 573 A1. Concerning the further design details of such an atomizer arrangement 90, reference is therefore made to that document, whose contents are hereby included here by reference to the disclosure content.

The feed line 76, which passes through the bottom 100 of the nozzle body 92 and also the first insert part 94 and protrudes into the volume area that is also surrounded by the essentially cylindrical area of the second insert part 96, which said essentially cylindrical area leads to the atomizer lip 102, can be further recognized from FIG. 9. The fuel cell waste gas fed in via this feed line 76 consequently enters from the feed line 76 a volume area in which the combustion air flows as well, here in the form of the inner swirl flow. Due to the swirl of this inner swirl flow, the fuel cell waste gas will be mixed with this inner swirl flow immediately after the discharge from the feed line 76 and, shortly thereafter, also with the outer swirl flow, and it will then enter the combustion chamber 50 in this mixture for combustion.

Consequently, FIG. 9 also shows a burner 34, which can be operated with fuel, i.e., preferably liquid fuel in this case, or with the fuel cell waste gas as desired. The fuel cell waste air can then be utilized as combustion air in this case as well, and it can also be used at the same time to atomize liquid fuel for the combustion if a liquid fuel is used.

It shall be pointed out that not only liquid fuel can be used to operate the burner 34 in all the burners 34 described above in the operating state in which, for example, the hydrogen-containing fuel cell waste gas is not yet available. If the fuel supply means 24 is designed correspondingly, it is, of course, also possible to use a gaseous fuel, e.g., natural gas, as a starting material to be burned with the fuel cell waste air.

While specific embodiments of the invention have been shown and described in detail to illustrate the application of the principles of the invention, it will be understood that the invention may be embodied otherwise without departing from such principles.

1. A fuel cell system, comprising:
a fuel cell;
a burner operated with fuel and/or fuel cell waste gas as desired;
a heat exchanger arrangement to transfer heat generated in said burner to air to be fed into said fuel cell and/or to a hydrogen-containing gas to be fed into said fuel cell.

2. A fuel cell system in accordance with claim 1, wherein said burner comprises a combustion chamber with a feed line for fuel, a feed line for fuel cell waste gas and a feed line for combustion air.

3. A fuel cell system in accordance with claim 2, wherein the fuel and the fuel cell waste gas are fed into said combustion chamber in a bottom area of said combustion chamber.

4. A fuel cell system in accordance with claim 3, wherein the fuel and the fuel cell waste gas are fed via a common feed line, said common feed line feeding the fuel and the fuel cell waste gas, respectively, in said bottom area in a direction of said combustion chamber.

5. A fuel cell system in accordance with claim 3, wherein the fuel and the fuel cell waste gas are fed via separate feed lines, which feed the fuel and the fuel cell waste gas, respectively, in said bottom area in a direction of said combustion chamber.

6. A fuel cell system in accordance with claim 2, wherein the combustion air is fed into said combustion chamber in a circumferential area or/and in a bottom area of said combustion chamber.

7. A fuel cell system in accordance with claim 2, wherein a premixing chamber is provided, in which at least part of the fuel cell waste gas and at least part of the combustion air are mixed before being fed into said combustion chamber.

8. A fuel cell system in accordance with claim 3, wherein a porous evaporator medium, preferably with a heating means, via which said evaporator medium at least the fuel is fed into said combustion chamber, is provided at least in said bottom area of said combustion chamber.

9. A fuel cell system in accordance with claim 1, wherein said burner has an atomizer arrangement with a feed line for liquid fuel, a feed line for combustion air, which is also fed in to atomize the fuel, and with a feed line for fuel cell waste gas.

10. A fuel cell system in accordance with claim 9, wherein
said atomizer arrangement has an outer swirl flow space and an inner swirl flow space to generate an outer swirl flow and an inner swirl flow leading to an atomizer lip; and
a feed means for fuel cell waste gas is provided comprising a feed line through which fuel cell waste gas is sent into the area of the inner swirl flow or/and the outer swirl flow.

11. A fuel cell system in accordance with claim 10, wherein said feed line passes through a flow guide element which defines said inner swirl flow space.

12. A fuel cell system, comprising:
an air feed line;
a hydrogen-containing gas feed line;
a fuel feed line;
a fuel cell with an intake connected to said air feed line, and to said hydrogen-containing gas feed line and with a waste gas discharge;
a burner having a combustion chamber with a fuel connection to one or both of said fuel feed line, said hydrogen-containing gas feed line and with a connection to said fuel cell waste gas and to said air feed line; and
a heat exchanger arrangement for transferring heat generated in said burner to air in said air feed line and/or to a hydrogen-containing gas in said hydrogen-containing gas feed line.

13. A fuel cell system in accordance with claim 12, wherein the fuel and the fuel cell waste gas are fed into said combustion chamber in a bottom area of said combustion chamber.

14. A fuel cell system in accordance with claim 13, wherein the fuel and the fuel cell waste gas are fed via a common feed line, said common feed line feeding the fuel and the fuel cell waste gas, respectively, in said bottom area in a direction of said combustion chamber.

15. A fuel cell system in accordance with claim 13, wherein the fuel and the fuel cell waste gas are fed via separate feed lines, which feed the fuel and the fuel cell waste gas, respectively, in said bottom area in a direction of said combustion chamber.

16. A fuel cell system in accordance with claim 12, wherein the combustion air is fed into said combustion chamber in a circumferential area or/and in a bottom area of said combustion chamber.

17. A fuel cell system in accordance with claim 12, wherein a premixing chamber is provided, in which at least part of the fuel cell waste gas and at least part of the combustion air are mixed before being fed into said combustion chamber.

18. A fuel cell system in accordance with claim 13, wherein a porous evaporator medium, preferably with a heating means, via which said evaporator medium at least the fuel is fed into said combustion chamber, is provided at least in said bottom area of said combustion chamber.

19. A fuel cell system in accordance with claim 12, wherein said burner has an atomizer arrangement with a feed line for liquid fuel, a feed line for combustion air, which is also fed in to atomize the fuel, and with a feed line for fuel cell waste gas.

20. A fuel cell system in accordance with claim 19, wherein
said atomizer arrangement has an outer swirl flow space and an inner swirl flow space to generate an outer swirl flow and an inner swirl flow leading to an atomizer lip; and
a feed means for fuel cell waste gas is provided comprising a feed line through which fuel cell waste gas is sent into the area of the inner swirl flow or/and the outer swirl flow, wherein said feed line passes through a flow guide element which defines said inner swirl flow space.
